(19) United States
(12) Patent Application Publication
(10) Pub. No.: US 2024/0139949 A1
(43) Pub. Date: May 2, 2024

(54) ROBOT, ROBOT CONTROL METHOD, ARTICLE MANUFACTURING METHOD, AND STORAGE MEDIUM

(71) Applicant: CANON KABUSHIKI KAISHA, Tokyo (JP)

(72) Inventor: MASUMITSU IWATA, Kanagawa (JP)

(21) Appl. No.: 18/492,659

(22) Filed: Oct. 23, 2023

(30) Foreign Application Priority Data
Nov. 2, 2022 (JP) 2022-175969
Sep. 15, 2023 (JP) 2023-149885

(51) Int. Cl. B25J 9/16

(52) U.S. Cl. CPC B25J 9/1664; B25J 9/1694

(57) ABSTRACT

A robot having a joint, the robot comprising a first position sensor and a second position sensor configured to acquire information about a position of the joint, wherein a first reference position of the first position sensor is acquired based on a second reference position of the second position sensor.

### BACKGROUND

### Field of the Disclosure

The present disclosure relates to a robot.

### Description of the Related Art

Robots have been used for the purpose of automation in manufacturing processes in factories. In such a robot, a rotation angle of a motor shaft or a joint angle is detected by one encoder to control the rotation angle of the motor shaft or the joint angle. A general encoder includes a scale for detecting an angle in one rotation and a storage medium for storing the number of rotations. Such a storage medium includes a battery, a capacitance, and the like in order to hold the number of rotations even when power supply to the robot is cut off, with no power supplied. However, the number of rotations held in the storage medium may be lost or the reliability may be reduced due to battery consumption, disconnection of a battery power supply line, a short circuit, or the like. As a result, a difference occurs in the encoder detection position before and after loss of the number of rotations, or before and after a decrease in reliability. For example, when the number of rotations corresponding to three rotations is lost, the three rotations is counted as zero rotation, and a difference corresponding to three rotations occurs before and after the loss of the number of rotations.

In a robot, a reference position for designating each joint angle is set for each joint in order to execute a desired operation by controlling each joint angle by driving a motor. However, as described above, when a difference occurs in the encoder detection position before and after the number of rotations is lost and before and after the reliability is reduced, the reference position originally set for each joint cannot be correctly acquired by the encoder, and a desired operation cannot be performed. Therefore, it is necessary to restore the reference position. Japanese Patent Application Laid-Open No. 2014-102179 discloses an example of such a method for restoring such a reference position. According to Japanese Patent Application Laid-Open No. 2014-102179, an encoder value acquired at the origin (reference position) of a mechanism unit is stored in a nonvolatile memory.

### SUMMARY

According to an aspect of the present disclosure, a robot having a joint, the robot comprising a first position sensor and a second position sensor configured to acquire information about a position of the joint, wherein a first reference position of the first position sensor is acquired based on a second reference position of the second position sensor.

Further features of the present disclosure will become apparent from the following description of exemplary embodiments with reference to the attached drawings.

### BRIEF DESCRIPTION OF THE DRAWINGS

FIG. 1 is a schematic diagram of a robot system according to an exemplary embodiment.

FIGS. 2A and 2B are control block diagrams of a robot system according to one or more aspects of the present disclosure.

FIG. 3 is a schematic diagram of an external input device according to one or more aspects of the present disclosure.

FIGS. 4A and 4B are a control flowchart according to one or more aspects of the present disclosure.

FIGS. 5A to 5C are display examples of an external input device according to one or more aspects of the present disclosure.

FIGS. 6A to 6C are a control flowchart according to one or more aspects of the present disclosure.

FIGS. 7A and 7B are control block diagrams of a robot system according to one or more aspects of the present disclosure.

FIG. 8 is a control flowchart according to the present exemplary embodiment.

FIGS. 9A and 9B are control block diagrams of a robot system according to one or more aspects of the present disclosure.

FIG. 10 is a control flowchart according to one or more aspects of the present disclosure.

FIG. 11 is a display example of an external input device according to one or more aspects of the present disclosure.

### DESCRIPTION OF THE EMBODIMENTS

In Japanese Patent Application Laid-Open No. 2014-102179, in order to align the reference positions of an encoder and a mechanism unit, the mechanism unit is manually operated to reset the reference positions of the encoder and the mechanism unit. However, the reliability of the detection value of the encoder after the battery exhaustion is low, and thus the detection value of the encoder before the battery exhaustion cannot be reproduced. For this reason, even if the reference position of the mechanism unit of the robot is matched using the value of the encoder after the battery is exhausted with the value of the reference position of the encoder before the battery is exhausted, which has been acquired as a backup, a considerable difference exists therebetween. Thus, there is a considerable difference between the reference position originally set in the robot and the reset reference position. Therefore, in order to reduce the fluctuation of the hand position and the working position of the robot, it is necessary to re-teach the robot operation based on the reset reference position. However, the re-teaching of the robot operation increases the stop time of the robot, causing a decrease in the operation rate.

According to exemplary embodiments of the present disclosure, the decrease of the operation rate of a robot is reduced even when the reliability of the detection position of an encoder for detecting the joint angle of the robot is lowered.

Hereinafter, exemplary embodiments of the present disclosure will be described with reference to the accompanying drawings.

Note that the exemplary embodiments described below are merely examples, and for example, a person skilled in the art can appropriately change a detailed configuration without departing from the scope of the present disclosure. In addition, the numerical values described in the exemplary embodiments are reference numerical values and do not limit the present disclosure. In the following drawings, arrows X, Y, and Z indicate the coordinate system of the entire robot system. In general, the XYZ three-dimensional coordinate system indicates the world coordinate system of an entire installation environment. In addition, for convenience of control or the like, a local coordinate system may be appropriately used for a robot hand, a finger portion, a joint, or the like.

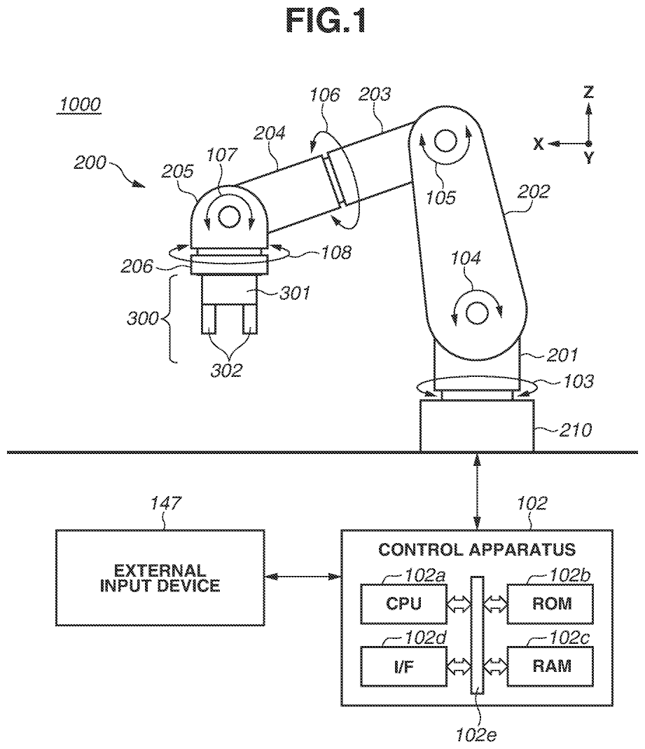

A first exemplary embodiment will be described. FIG. 1 is a schematic diagram of a configuration of a robot system to which the present disclosure can be applied. A robot system 1000 according to the present exemplary embodiment includes a robot arm body 200, a robot hand body 300, a control apparatus 102, and an external input device 147.

By grasping, manipulating, and assembling a workpiece, which is a target object, to another workpiece by the robot system 1000, the assembled workpiece can be manufactured as an industrial product or an article. For example, an operation on a workpiece to be grasped is performed by grasping and moving the workpiece to be grasped using the robot arm body 200 and the robot hand body 300, and fitting or assembling the workpiece to another workpiece. The external input device 147 is connected to the control apparatus 102 via an interface (I/F) 102d and a bus 102e. The external input device 147 is, for example, a teaching pendant including an operation unit, such as a touch panel or a button, and the touch panel includes a graphical user interface (GUI).

In the present exemplary embodiment, the robot arm body 200 is a multi-joint robot arm, and the base of the robot arm body 200 is fixed. The robot arm body 200 includes a base portion 210 and a plurality of links 201, 202, 203, 204, 205, and 206 which are respectively connected by a plurality of joints 103, 104, 105, 106, 107, and 108 which are rotationally driven. The link 201 is connected to the base portion 210. Each joint of the robot arm body 200 is provided with a motor as a drive source for driving the joint, a reduction gear, an encoder as position detecting means for detecting a rotation angle of the motor, and a torque sensor for detecting a force. As will be described below, in the present exemplary embodiment, the encoders are provided in a redundant manner, and two encoders are provided for each joint.

The robot hand body 300 is attached to the link 206, which is an end portion of the robot arm body 200. The robot hand body 300 and the link 206 are rotatable via the joint 108. By driving the joints 103 to 108 of the robot arm body 200, the robot arm body 200 can be positioned in various positions and orientations, and the robot hand body 300 can be positioned in various positions and orientations.

The robot hand body 300 serving as an end effector is attached to the end portion of the robot arm body 200. The robot hand body 300 includes a hand base portion 301, and a finger portion 302 is provided on the hand base portion 301. The end effector is a predetermined portion of the robot arm body 200.

The control apparatus 102 includes a central processing unit (CPU) 102a, a read only memory (ROM) 102b, and a random access memory (RAM) 102c. The control apparatus 102 also includes the I/F 102d for communication with the outside. These components are configured to communicate with each other via the bus 102e. The ROM 102b stores programs each for controlling the corresponding driving unit in accordance with various operations of the robot arm body 200. The RAM 102c functions as a work area of the CPU 102a.

The I/F 102d functions as an interface for communicating with the robot arm body 200, the robot hand body 300, and the external input device 147. The CPU 102a calculates an angle to be taken by each joint for a target position and orientation of the end portion of the robot arm body 200, which is a destination of the robot hand body 300. Then, a command value is output to a servo circuit (not shown) for controlling the motor of each joint via the I/F 102d, and each joint of the robot arm body 200 is controlled to be driven. Thus, the workpiece can be manipulated by the robot hand body 300.

The external input device 147 may be, for example, an operation device, such as a teaching pendant (TP), but may be another computer device (a PC or a server) capable of editing robot programs. The external input device 147 can be connected to the control apparatus 102 via wired or wireless communication connection means, and has a user interface function, such as robot operation and status display. For example, the CPU 102a receives teaching point data input on the external input device 147 from the I/F 102d. Trajectories of the robot arm body 200 and the robot hand body 300 can be generated based on the teaching point data input on the external input device 147 and transmitted to the robot arm body 200 and the robot hand body 300 as control target values via the I/F 102d.

With the above configuration, the robot hand body 300 can be moved to a desired position by the robot arm body 200 to perform a desired operation. For example, by using a predetermined workpiece and another workpiece as materials and performing a process of assembling the predetermined workpiece and the other workpiece, an assembled workpiece can be manufactured as a product. Further, a tool capable of performing cutting and polishing may be mounted as the robot hand body 300, and a workpiece processed by the tool may be used as an article manufactured as a product. As described above, an article can be manufactured by the robot arm body 200.

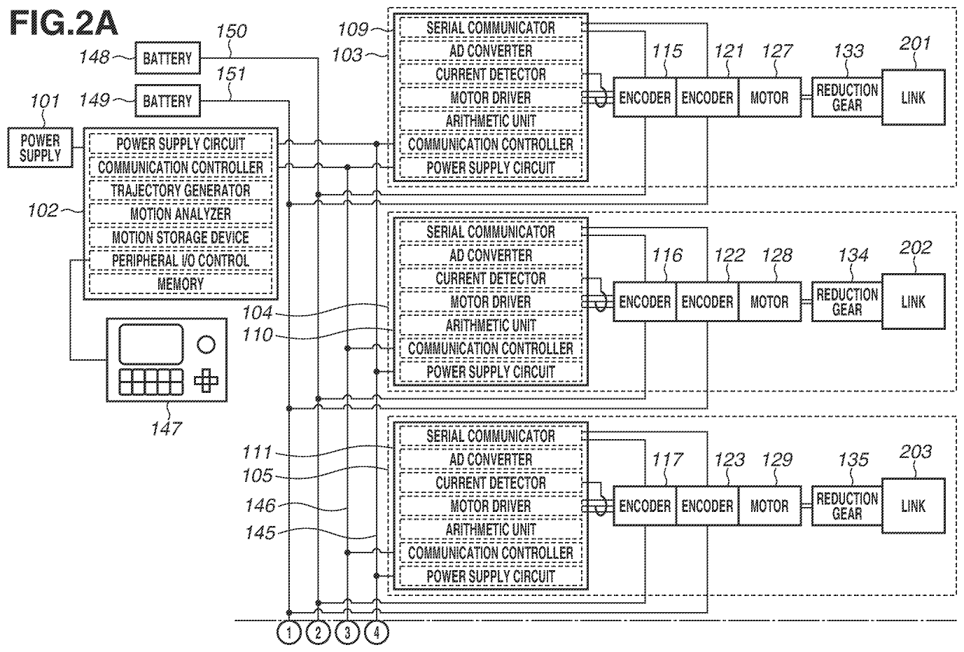

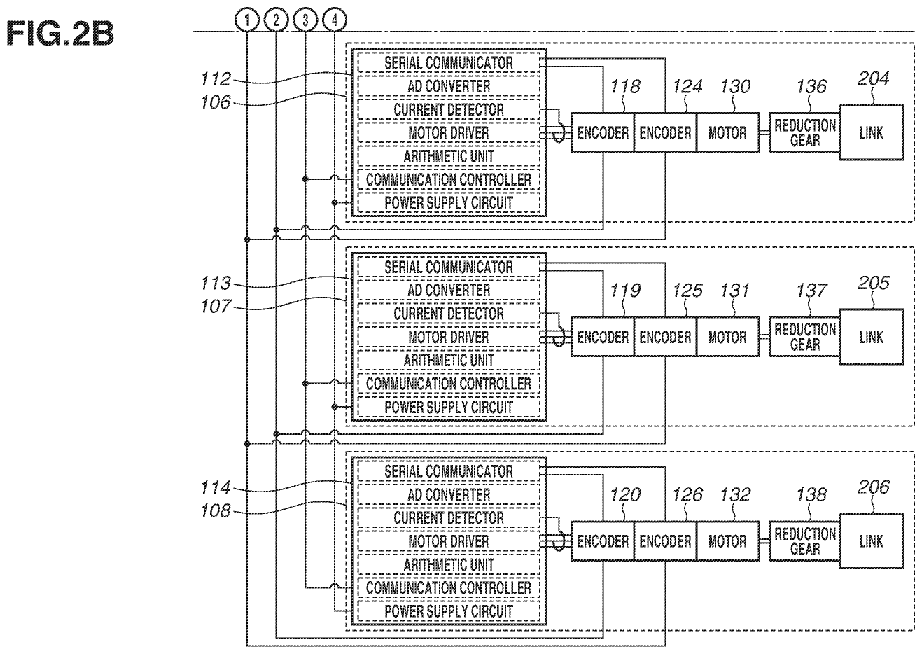

FIGS. 2A and 2B are a control block diagram of the robot system 1000 according to the present exemplary embodiment. The present exemplary embodiment will be described using a serial link robot system in which an encoder is redundantly provided for each joint. As illustrated in FIG. 2, the robot arm body 200 has a six-axis configuration, and motor control boards 109, 110, 111, 112, 113, and 114 for driving motors 127, 128, 129, 130, 131, and 132, respectively, are included in the joints 103 to 108. The motors 127 to 132 are respectively connected to reduction gears 133, 134, 135, 136, 137, and 138 that reduce the speed of output from each of the motors and transmit the reduced output to the corresponding link. The links 201, 202, 203, 204, 205, and 205 are connected to the respective reduction gears. In addition, electric power is supplied to each of the motors 127 to 132 and each of the motor control boards 109 to 114 by the power source 101 through the power supply line 145.

On each of the motor control boards 109 to 114, a communication controller for communicating with the control apparatus 102 that generates drive information of each joint, a motor driver, a power supply circuit that drives an arithmetic unit, and an arithmetic unit that executes motor control processing are mounted. Further, a driver for driving the corresponding motor, a current detector for measuring a current flowing through a motor driving line, an analog-to-digital (AD) converter for converting an output voltage from the current detector into a digital value, and a serial communicator for performing serial communication control with corresponding encoders are mounted.

Further, the motors 127 to 132 for driving the respective joints are connected to the motor control boards 109 to 114, respectively, and an absolute position encoder (hereinafter referred to as an encoder) for detecting a motor shaft rotation angle is provided on a motor shaft of each of the motors 127 to 132. The encoders are redundant, and the rotation angles of the motor shafts of the motors 127 to 132 are detected by the encoders 115, 116, 117, 118, 119, 120, 121, 122, 123, 124, 125, and 126, respectively. A backup battery 148 used as a power source for maintaining the numbers of rotations of the motor shafts when the power supply from the power supply 101 is stopped is connected to the encoders 115 to 120 via a backup power supply line 150. Similarly, a backup battery 149 is connected to the encoders 121 to 126 via a backup power supply line 151. The backup batteries 148 and 149 are provided in the respective encoders. In FIG. 2, the backup batteries 148 and 149 and the backup power supply lines 150 and 151 are collectively illustrated. The backup batteries 148 and 149 may be referred to as power supply units.

The encoders 115 to 120 and the encoders 121 to 126 are respectively connected to the motor control boards 109 to 114 via serial communication lines, and exchange encoder information through serial communication. The encoders 115 to 120 and 121 to 126 transmit rotation angles of motor shafts, encoder states, and voltage values of the backup batteries 148 and 149. The transmitted information related to the encoders is displayed on a monitor (display unit) of the external input device 147 via the control apparatus 102. The monitor mounted on the external input device 147 is of a touch panel type, and can be operated by a user touching an operation screen.

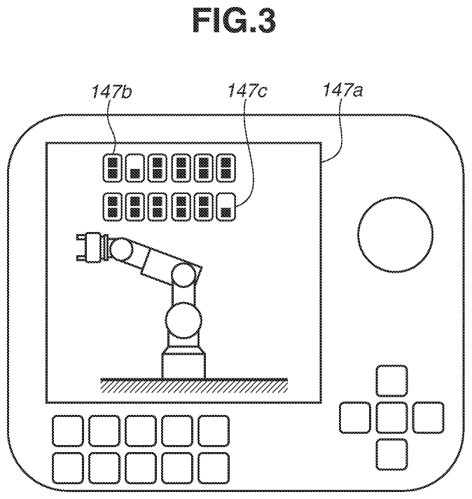

Here, FIG. 3 illustrates an example of a screen displayed on the monitor mounted on the external input device 147. Symbols for visually notifying the user of voltage detection values of the backup batteries connected to the encoders 115 to 120 and 121 to 126 included in the joints 103 to 108 are displayed on the upper portion of a monitor 147a. Icons 147b in the upper row display the encoders 115 to 120 included in the respective joints, and icons 147c in the lower row display voltage detection values of the backup battery of the encoders 121 to 126. When the voltage detection values of the backup batteries become equal to or lower than a predetermined voltage, a voltage drop warning message for the backup batteries may be displayed on the monitor 147a, or the user may be notified by a warning sound.

Returning to FIGS. 2A and 2B, each arithmetic unit is connected to the control apparatus 102 via a communication unit and the serial communication line 146. Then, processing of driving the motor is executed based on command information including a control target value of each joint generated by a trajectory generator mounted on the control apparatus 102 and information on an encoder connected via the serial communication line and the serial communicator. In addition, as a response to command information transmitted from the control apparatus 102, processing of transmitting a rotation angle of a motor shaft, a voltage of a backup battery, error information, and the like to the control apparatus 102 is executed. The transmission and reception of command information and command responses between the control apparatus 102 and the motor control boards 109 to 114 are periodically performed. In the present exemplary embodiment, the transmission and reception are performed in a cycle of two milliseconds.

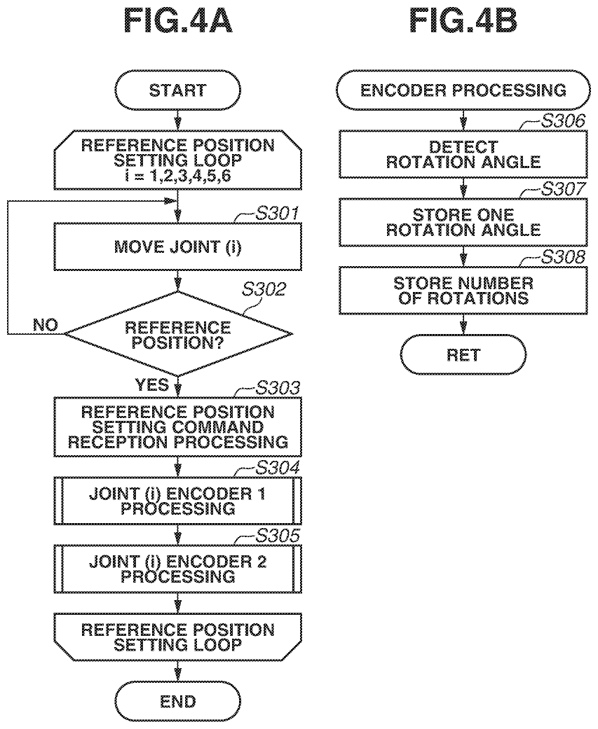

Next, setting of a reference position of a joint in the present exemplary embodiment will be described with reference to FIGS. 4A and 4B. FIG. 4A is a control flowchart relating to the setting of a reference position, and FIG. 4B illustrates details of the processing of step S304 and step S305 in FIG. 4A. The control procedure in the present exemplary embodiment is executed by the CPU 102a of the control apparatus 102 and the motor control boards 109 to 114 of the respective joints.

Referring to FIG. 4A, first, in step S301, each of the joints of the robot arm body 200 are manually driven or manually moved to the reference positions of the joints.

In step S302, the determination of whether the joints have moved to the reference positions is made by determining whether each joint position is the corresponding reference position by matching a mark indicating the reference position on a link (housing portion) between joints or by fitting a predetermined pin into a reference position hole provided in each joint. After each joint is moved to the corresponding reference position, a reference position setting command is transmitted from the control apparatus 102 in a state where each joint is stopped. The transmission of the reference position setting command from the control apparatus 102 may be performed automatically by detecting a manual operation by an operator or a movement to a reference position by a sensor or the like.

Then, in step S303, each of the motor control boards 109 to 114 generates response information for the reference position setting command as reference position setting command reception processing, and then transmits the response information for the reference position setting command to the control apparatus 102 via the communication controller and the communication line.

Then, the arithmetic units mounted on the motor control boards 109 to 114 execute step processing in steps S304 and S305 serving as encoder processing. In steps S304 and S305, the same processing is executed for the two redundant encoders. In the present exemplary embodiment, in step S304, the processing for the encoders 115 to 120 is performed, and in step S305, the processing for the encoders 121 to 126 is performed. However, the processing may be reversed.

The processing executed in steps S304 and S305 will be described in detail with reference to FIG. 4B. In step S306, the arithmetic units mounted on the motor control boards 109 to 114 acquire rotation angles of the motor shafts from the encoders through serial communication, and calculate a rotation angle θ within one rotation based on the rotation angle of each motor shaft and the resolution of each encoder and the number of rotations n of the motor shaft.

Next, in step S307, the rotation angle θ is stored in a nonvolatile memory. Next, in step S308, the value of the number of rotations n is stored in the nonvolatile memory. The nonvolatile memory to store the rotation angle θ and the number of rotations n may be a memory incorporated in the encoder, memories mounted on the motor control boards 109 to 114, or a memory mounted on the control apparatus 102, and an electrically erasable programmable read-only memory (EEPROM), a flash memory, or a hard disk. The nonvolatile memory may be referred to as a storage unit.

As described above, the information on the reference position in each joint and each encoder of the robot arm body 200 is set. Steps S301 to S308 described above are performed by the number of joints included in the robot arm body 200. In the present exemplary embodiment, since the number of joints of the robot arm body 200 is six, the operation is performed six times.

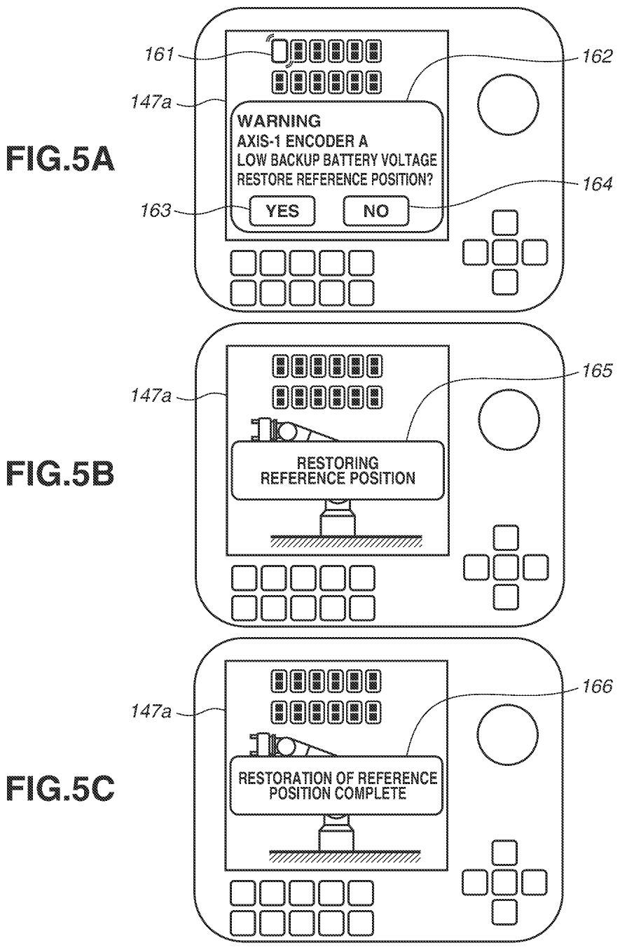

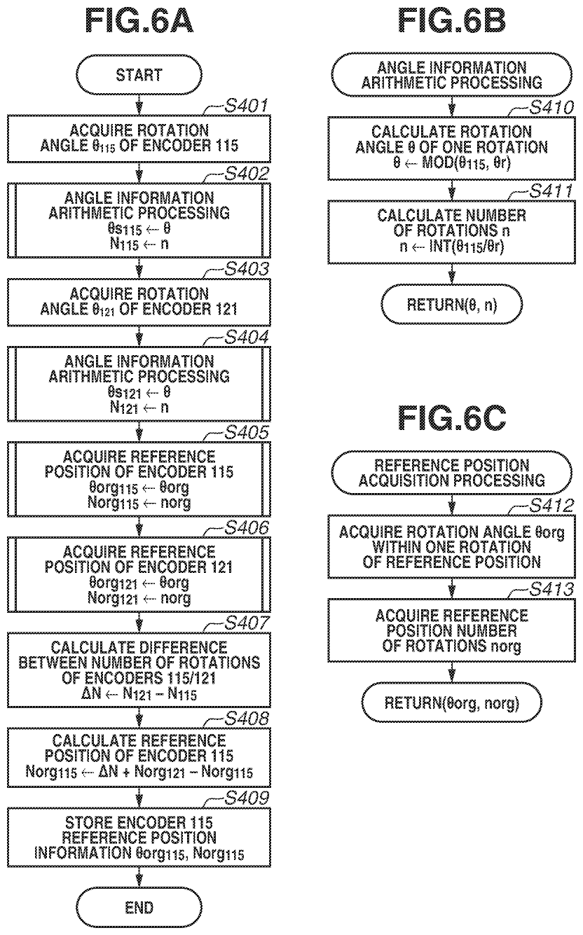

Next, a method for restoring a reference position of an encoder in the present exemplary embodiment will be described with reference to FIGS. 5A, 5B, 5C, 6A, 6B, and 6C. With reference to FIGS. 5A, 5B, 5C, 6A, 6B, and 6C, a method of restoring a detection value of the encoder 115 and the reference position when the reliability of the detection value of the encoder 115 decreases due to a decrease in the voltage of the backup battery will be described. Similar processing is performed in the other encoders. FIG. 5A is a diagram illustrating a state where the user selects execution of restoration of a reference position of an encoder. FIG. 5B is a diagram illustrating a state where the user is notified of execution of restoration of the reference position of the encoder. FIG. 5C is a diagram illustrating a state where the user is notified that the restoration of the reference position of the encoder has been completed.

FIG. 6A illustrates a control flowchart relating to the reference position restoration. FIG. 6B illustrates details of the processing in steps S402 and S404 in FIG. 6A. FIG. 6C illustrates details of the processing in steps S405 and S406 in FIG. 6A. The control procedure in the present exemplary embodiment is executed by the CPU 102a of the control apparatus 102 and the motor control boards 109 to 114 of the respective joints.

As illustrated in FIG. 5A, the motor control board 109 returns, as a response to the request transmitted to the encoder 115 by serial communication, information about the detection value and the encoder state including the voltage value of the backup battery to the control apparatus 102. In a case where the voltage value of the backup battery is equal to or less than a predetermined value set in advance, it is determined that the reliability of the detection value of the encoder 115 is reduced, and a message 162 shown in FIG. 5A is displayed on the monitor 147a mounted on the external input device 147. The user can recognize that there is an abnormality in the rotation angle information on the encoder 115 (displayed as “shaft 1 encoder A” in FIG. 5A) by the warning display. Further, in FIG. 5A, the voltage display 161 for displaying the voltage state of the backup battery of the encoder 115 is displayed in an empty state, and the voltage display 161 is displayed in a blinking manner. In the present exemplary embodiment, the encoder 115 may be referred to as a first position sensor, and the encoder 121 may be referred to as a second position sensor. Further, the reference position of the encoder 115 may be referred to as a first reference position, and the reference position of the encoder 121 may be referred to as a second reference position.

In the present exemplary embodiment, notification to the user is performed by displaying a warning message or the like on the monitor 147a mounted on the external input device 147. However, in a system in which a monitor or the like is not mounted, an indicator, such as a display lamp, is installed at each joint in the robot arm body 200. Then, the occurrence of an abnormality of an encoder may be notified by lighting or blinking the indicator lamp or the like of the target joint on which the encoder that has detected the abnormality is mounted, or by lighting the indicator lamp in a preset color.

The user removes the cause of the abnormality, such as the replacement of the backup battery of the encoder 115 or the disconnection of the wiring to the backup battery in response to the warning message, and then presses the execution button 163 to permit the execution of the restoration processing of the encoder detection value and the reference position and the processing is started.

When the cancel button 164 is pressed, the restoration processing of the encoder detection value and the reference position is not executed, and the display of the message 162 and the blinking display of the voltage display 161 are ended. At this time, the voltage display 161 is set to a full display.

During the execution of the restoration processing of the encoder detection value and the reference position, a message 165 illustrated in FIG. 5B is displayed, and a message indicating that the restoration processing of the encoder detection value and the reference position is being executed is displayed. Then, when the execution of the restoration processing of the encoder detection value and the reference position to be described below is completed, a message 166 is displayed on the monitor 147a to notify the user that the restoration processing of the detection value and the reference position of the encoder 115 is completed. The message 162 may be referred to as a first message, the message 165 may be referred to as a second message, and the message 166 may be referred to as a third message.

Next, a processing flowchart executed in the restoration processing of an encoder detection value and a reference position will be described with reference to FIG. 6A. 6B, and 6C. The execution of the restoration processing is started by the user operation described in FIG. 5, and in step S401, a current detected rotation angle θ₁₁₅ is acquired from the encoder 115 in which the abnormality has occurred.

Next, in step S402, angle information arithmetic processing for calculating the rotation angle θs₁₁₅ within one rotational range and the number of rotations Nui from the detected rotation angle θ₁₁₅. As shown in FIG. 6B, in the angle information calculation processing, in step S410, the remainder of the one rotation resolution θr of the encoder 115 is calculated from the detected rotation angle θ₁₁₅. A symbol MOD (X, Y) in step S410 represents processing of calculating a remainder obtained by dividing X by Y.

Then, in step S411, the number of rotations is calculated. The symbol INT(X) in step S411 represents processing of rounding down the fractional part of X to an integer.

Next, in steps S403 and S404, similar processing to that for the encoder 115 is executed for the encoder 121 to obtain a rotation angle θs₁₂₁ within one rotational range and the number of rotations N₁₂₁. The encoder 121 is an encoder that acquires the rotation angle of the same joint 103 as the encoder 115.

Next, the processing in steps S405 and S406 for acquiring reference position information stored in the nonvolatile memories of the encoders 115 and 121 is executed. In steps S405 and S406, a rotation angle θorg within one rotational range of each encoder is read from the nonvolatile memory in step S412, as shown in FIG. 6C. Then, in step S413, the number of rotations norg is read from the nonvolatile memories, and substituted into the reference position rotation angles θorg₁₁₅ and θorg₁₂₁ and the numbers of rotations Norg₁₁₅ and Norg₁₂₁ within one rotational range as the internal processing variables. The θorg₁₁₅ and Norg₁₁₅ read from the nonvolatile memory are reference position information before the abnormality of the encoder 115 is detected.

Subsequently, in step S407, the difference ΔN in the current number of rotations is calculated from the number of rotations N₁₁₅ of the encoder 115 and the number of rotations N₁₂₁ of the encoder 121.

Next, in step S408, the number of rotations of the reference position Norg₁₁₅ after the occurrence of the abnormality of the encoder 115 is newly calculated from the current difference ΔN between the numbers of rotations Nils and N₁₂₁ and the numbers of rotations Norg₁₁₅ and Norg₁₂₁ in the reference position information, and is then substituted into the Norg₁₁₅.

Next, in the processing of step S409, the reference position rotation angle θorg₁₁₅ within one rotational range and the Norg₁₁₅ calculated in the reference position restoration processing are stored in the nonvolatile memory as reference position information on the encoder 115.

After the processing in step S409, a message 166 is displayed on the external input device 147 to notify the user that the restoration processing on the detection value of the encoder 115 and the reference position is completed, and the processing is ended.

As described above, in the present exemplary embodiment, the reference position and the detection value in the encoder 115 in which the abnormality has occurred are restored with the encoder 121 in which the abnormality has not occurred. The information on the encoder 121 is equivalent to the information on the encoder 115 before the occurrence of the abnormality, and the reference position rotation angle θorg₁₁₅ within one rotational range is not changed before and after the abnormality detection of the encoder 115. In this way, the reference position before the abnormality detection of the encoder 115 can be restored. Since the information on the encoder 115 is restored with the encoder information (information on the encoder 121) before the abnormality occurrence, it is not necessary to reset the reference position of the encoder 115 and the reference position of the joint 103, and thus it is not necessary to re-teach the operation of the robot arm body 200. As a result, it is possible to reduce the stop time of the robot and to reduce a decrease in the operation rate of the robot. In addition, even when the detection angle resolution of the encoder 115 is different from the detection angle resolution of the encoder 121, restoration can be performed.

In particular, in recent years, as an industrial robot that performs automatic assembly, a robot that cooperates with people has been under development. Conventionally, in order to avoid contact between people and a robot, an industrial robot performs work in a range of space isolated from people. However, a robot that cooperates with people is required to perform work in a contiguous space close to people. In a robot that cooperates with people, various safety measures are taken to reduce harm to people due to a malfunction of the robot. For example, as in the present exemplary embodiment, encoder failure detection is performed with a redundant configuration (at least two position detectors (hereinafter referred to as encoders) for detecting each joint angle of an industrial robot are mounted on each joint). Such a collaborative robot often has a redundant encoder configuration, and the present exemplary embodiment can be particularly effective.

In the first exemplary embodiment described above, a redundant robot system in which at least two encoders are mounted on each motor has been described as an example. However, the present disclosure can also be applied to a robot system equipped with an input shaft encoder that detects a rotation angle of a motor shaft and an output shaft encoder that detects a rotation angle of a portion rotated by a reduction gear. A second exemplary embodiment will be described in detail. In the following description, basic portions of the hardware configuration, the configuration of the display screen, and the like are the same as those of the above-described exemplary embodiment, and a detailed description thereof will be omitted. In the following exemplary embodiments, the same or substantially the same members are denoted by the same reference numerals, and a detailed description thereof will be omitted.

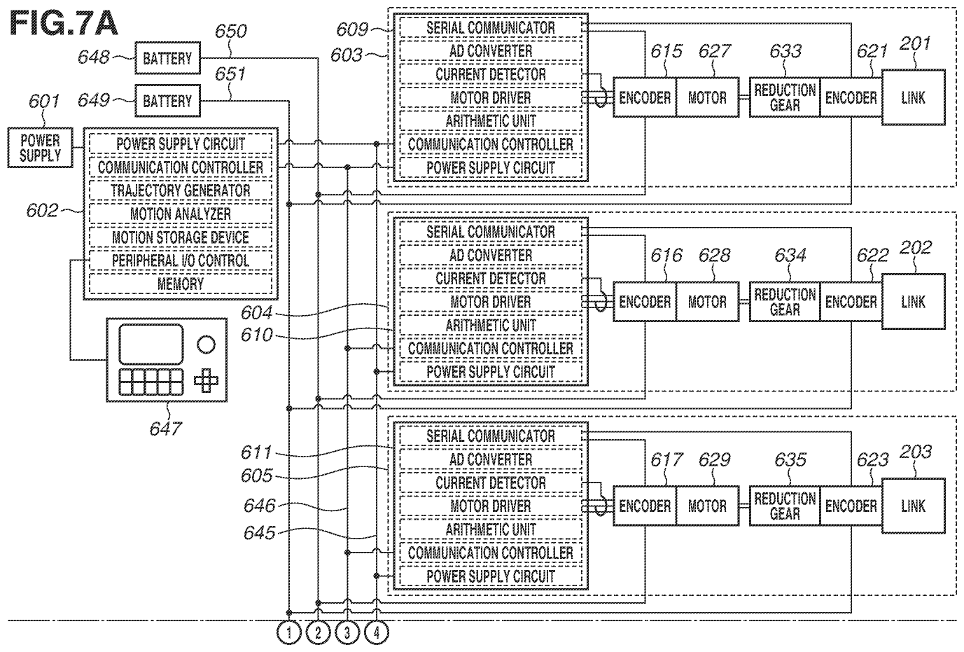

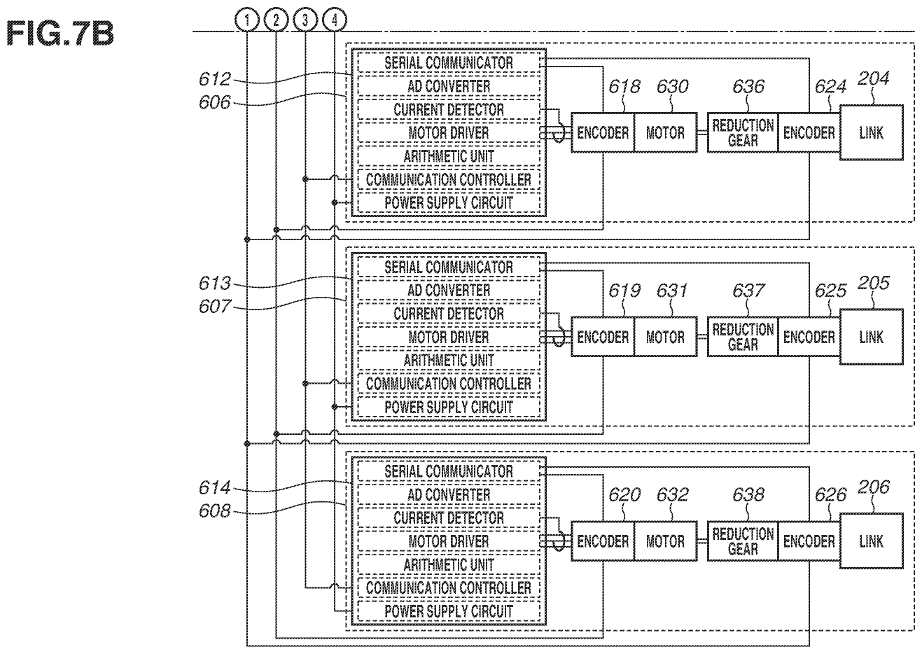

FIGS. 7A and 7B are control block diagrams of the robot system 1000 according to the present exemplary embodiment. As shown in FIGS. 7A and 7B, the robot system has a redundant configuration in which an encoder for detecting a rotation angle of a motor shaft and an encoder on a joint (output) side connected via a reduction gear are installed in each joint. The robot arm body 200 of the present exemplary embodiment has a six-axis configuration, and includes encoders 615, 616, 617, 618, 619, and 620 that detect rotation angles of motor axes of motors 627, 628, 629, 630, 631, and 632 that drive the respective joints. Further, motor control boards 609, 610, 611, 612, 613, and 614 are provided.

In addition, encoders 621, 622, 623, 624, 625, and 626 that detect rotation angles of joint rotation shafts via reduction gears 633, 634, 635, 636, 637, and 638 connected to the motor shafts are installed. The motor control boards 609 to 614 are communicably connected to the encoders 615 to 620 and the encoders 621 to 626. Other configurations of the robot system, a control apparatus 602, the motor control boards 609, 610, 611, 612, 613, and 614, the handshake command, and the command response information are the same as those in the first exemplary embodiment. Information for handshaking between the motor control boards 609 to 614, the encoders 615 to 620, and the encoders 621 to 626 is the same as that in the first exemplary embodiment. Further, the reference position setting processing of the joint according to the present exemplary embodiment is the same as that of the first exemplary embodiment (FIG. 4). In addition, electric power is supplied to each of the motors 627 to 632 and each of the motor control boards 609 to 614 by a power supply 601 through a power supply line 645.

On the motor control boards 609 to 614, a communication controller for communicating with the control apparatus 602 that generates driving information on each joint, a motor driver, a power supply circuit that drives an arithmetic unit, and an arithmetic unit that executes motor control processing are mounted. Further, a driver for driving the corresponding motor, a current detector for measuring a current flowing through a motor driving line, an AD converter for converting an output voltage from the current detector into a digital value, and a serial communicator for performing serial communication control with corresponding encoders are mounted.

The encoders 615 to 620 are connected to a backup battery 648, which is used as a power source for maintaining the number of rotations of a motor shaft when the power supply from the power supply 601 is stopped, via a backup power supply line 650. Similarly, a backup battery 649 is connected to the encoders 621 to 626 via a backup power supply line 651. The backup batteries 648 and 649 are provided for the corresponding respective encoders. In FIG. 7, the backup batteries 648 and 649 and the backup power supply lines 650 and 651 are collectively illustrated. The backup batteries 648 and 649 may be referred to as power supply units.

The encoders 615 to 620 and 621 to 626 are respectively connected to the motor control boards 609 to 614 via serial communication lines, and exchange encoder information via serial communication. The encoders 615 to 620 and 621 to 626 transmit rotation angles of motor shafts, encoder states, and voltage values of the backup batteries 648 and 649. The transmitted information related to an encoder is displayed on a monitor (display unit) of an external input device 647 via the control apparatus 602. The monitor mounted on the external input device 647 is of a touch panel type, and can be operated by a user touching an operation screen.

Each arithmetic unit is connected to the control apparatus 602 via the communication unit and a serial communication line 646. Processing for driving a motor is executed based on command information including a control target value of each joint generated by a trajectory generator mounted on the control apparatus 602 and information on an encoder connected via the serial communication line and the serial communicator. In addition, as a response to command information transmitted from the control apparatus 602, processing of transmitting a rotation angle of a motor shaft, a voltage of a backup battery, error information, and the like to the control apparatus 602 is executed. The transmission and reception of command information and command responses between the control apparatus 602 and the motor control boards 609 to 614 are periodically performed. In the present exemplary embodiment, the transmission and reception are performed in a cycle of 2 milliseconds.

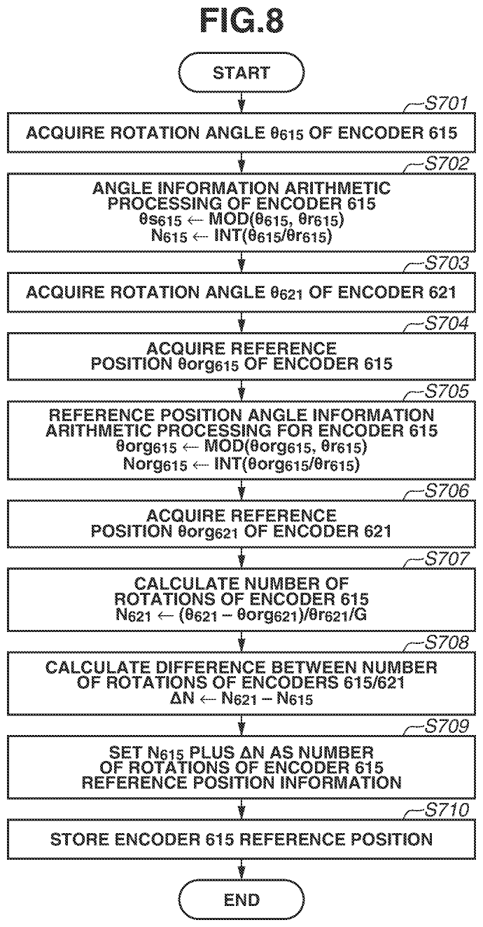

Next, a method of restoring a detected rotation angle and a reference position when the reliability of the detected rotation angle of the encoder 615 is reduced will be described with reference to FIG. 8. FIG. 8 is a control flowchart of a reference position restoration method in the present exemplary embodiment. The control procedure in the present exemplary embodiment is executed by a CPU of the control apparatus 602 and the motor control boards 609 to 614 of the respective joints.

In FIG. 8, in step S701, a detected rotation angle θ₆₁₅ of the encoder 615 is acquired, and in step S702, the number of rotations N₆₁₅ is calculated. Here, the symbol MOD(X, Y) represents processing of calculating a remainder obtained by dividing X by Y, and INT(X) represents processing of rounding down X to an integer.

In step S703, a detected rotation angle θ₆₂₁ of the encoder 621 is acquired. Next, in step S704, reference position information on the encoder 615 is read out from a nonvolatile memory, and in step S705, processing of calculating a rotation angle θorg₆₁₅ and the number of rotations N₆₁₅ within one rotational range of the reference position of the encoder 615 is executed.

In step S706, processing of reading the reference position information on the encoder 621 from the nonvolatile memory and substituting the reference position information into θorg₆₂₁ is executed. Next, in step S707, processing of calculating the number of rotations of the encoder 615 from the detected rotation angle θ₆₂₁ acquired by the encoder 621, θorg₆₂₁, a rotation angle detection resolutions θr₆₂₁ of the encoder 621 and a reduction ratio G of the reduction gear 633 is executed.

Next, in step S708, a difference ΔN between the number of rotations N₆₂₁ of the encoder 615 calculated from the detected rotation angle θ₆₂₁ acquired from the encoder 621 and the number of rotations N₆₁₅ of the encoder 615 calculated from the detected rotation angle θ₆₁₅ acquired from the encoder 615 is calculated.

Next, in step S709, processing for setting a value obtained by adding the difference ΔN in the number of rotations calculated in step S708 to the number of rotations N₆₁₅ of the encoder 615 calculated in step S702 as the number of rotations in the reference position information on the encoder 615.

Then, in step S710, the newly calculated number of rotations N₆₁₅ in the reference position information and the detected rotation angle θorg₆₁₅ within one rotational range are stored in the nonvolatile memory, and the processing is terminated.

As described above, according to the present exemplary embodiment, the reference position and the detection value of the encoder 615 in which the abnormality has occurred are restored with the encoder 621 in which the abnormality has not occurred. The information on the encoder 621 can be made equivalent to the information on the encoder 615 before the occurrence of the abnormality by performing processing based on the information on the reduction ratio of the reduction gear. In addition, since the reference position rotation angle θorg 615 within one rotational range is not changed before and after the abnormality detection of the encoder 615, the reference position before the abnormality detection of the encoder 615 can be restored. Since the information on the encoder 615 is restored with the encoder information (information on the encoder 621) before the abnormality occurs, it is not necessary to reset the reference position on the encoder 615 and the reference position of a joint 603, and it is not necessary to re-teach the operation of the robot arm body 200. Therefore, it is possible to reduce the stop time of the robot and to reduce a decrease in the operation rate of the robot. In addition, even when the detection angle resolution of the encoder 615 and the detection angle resolution of the encoder 621 are different from each other, restoration is possible. Further, the above-described first exemplary embodiment and modifications may be implemented in combination with the present exemplary embodiment.

In the above-described exemplary embodiments, the robot system in which at least two encoders are mounted on each motor, or in which an encoder for detecting a rotation angle of the rotation shaft of a motor and an encoder for detecting a rotation angle of an output shaft rotated via a reduction gear are mounted has been described. The present disclosure can also be applied to a robot system in which an absolute position encoder which holds multi-rotation data and an absolute position encoder for detecting a one rotation position (does not hold multi-rotation data) are mounted as a redundant configuration. A third exemplary embodiment will be described in detail. In the following description, basic portions of the hardware configuration, the configuration of the display screen, and the like are the same as those of the above-described exemplary embodiments, and a detailed description thereof will be omitted. In the following exemplary embodiment, the same or substantially the same members are denoted by the same reference numerals, and a detailed description thereof will be omitted.

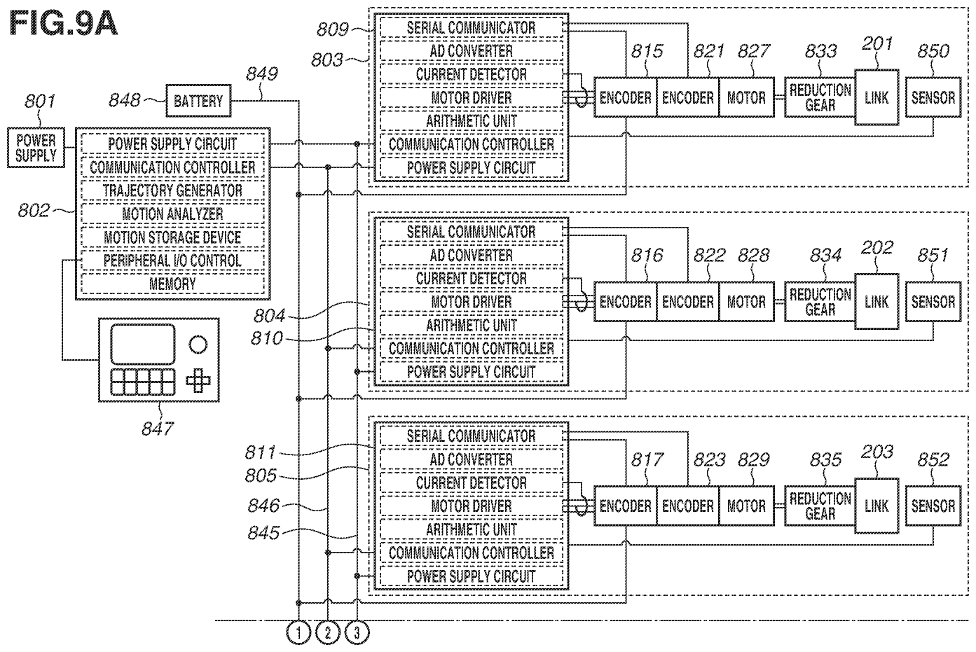

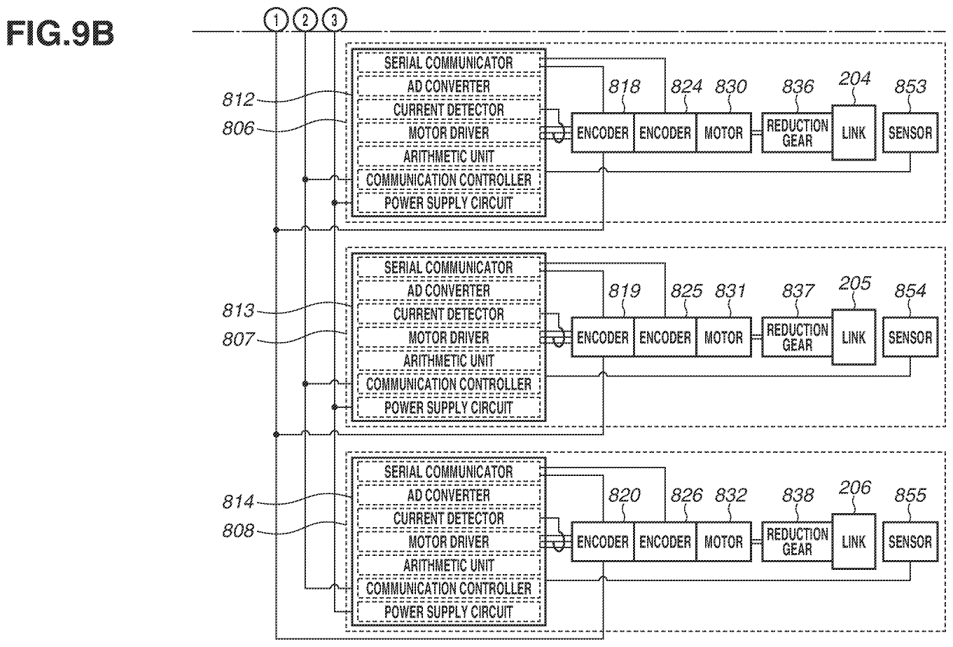

FIGS. 9A and 9B are control block diagrams of the robot system 1000 according to the present exemplary embodiment. In this exemplary embodiment, a serial link robot system in which absolute position encoders are redundantly provided for each joint will be described. As shown in FIG. 9, the robot arm body 200 has a six-axis configuration and includes joints 803, 804, 805, 806, 807, and 808. Motor control boards 809, 810, 811, 812, 813, and 814 for driving motors 827, 828, 829, 830, 831, and 832 are installed in the respective joints. The motors 827 to 832 is each connected to respective reduction gears 833, 834, 835, 836, 837, and 838 that reduce the speed of output from the corresponding motor and transmit the output to the corresponding link. The links 201, 202, 203, 204, 205, and 206 are connected to the respective reduction gears. In addition, electric power is supplied to each of the motors 827 to 832 and each of the motor control boards 809 to 814 by a power supply 801 through a power supply line 845.

On the motor control boards 809 to 814, a communication controller for communicating with a control apparatus 802 that generates driving information on each joint, a motor driver, a power supply circuit that drives an arithmetic unit, and an arithmetic unit that executes motor control processing are mounted. Further, a driver for driving the corresponding motor, a current detector for measuring a current flowing through a motor driving line, an AD converter for converting an output voltage from the current detector into a digital value, and a serial communicator for performing serial communication control with an encoder are mounted.

Further, the motors 827 to 832 for driving the respective joints are connected to the motor control boards 809 to 814, respectively, and an absolute position encoder (hereinafter referred to as an encoder) for detecting a motor shaft rotation angle is provided on a motor shaft of each of the motors 827 to 832. The encoders are redundant, and the encoders 815, 816, 817, 818, 819, 820, and encoders 821, 822, 823, 824, 825, and 826 detect motor shaft rotation angles of the motors 827 to 832, respectively. The encoders 815 to 820 are connected to a backup battery 848, which is used as a power source for maintaining the number of rotations of a motor shaft when the power supply from the power supply 801 is stopped, via a backup power supply line 849. The backup battery 848 is provided for each encoder. In FIGS. 9A and 9B, the backup battery 848 and the backup power supply line 849 are collectively shown. The backup battery 848 may be referred to as a power supply unit. The encoders 815 to 820 are absolute position encoders that hold multi-rotation data.

In the present exemplary embodiment, the encoders 821 to 826 serving as absolute position encoders for detecting a one rotation position are each engaged with the corresponding motor shaft to detect a rotation angle of the motor shaft. Note that the encoders 821 to 826 may be installed on the output shaft side that detects a rotation angle of a rotating portion via a reduction gear or the like. The encoders 821 to 826 can detect rotation angle information within one rotational range, and are not equipped with a backup battery. That is, the encoders 821 to 826 do not hold multi-rotation data. The joints are respectively provided with sensors 850, 851, 852, 853, 854, and 855 that acquire information about force. The sensors 850 to 855 are connected to the motor control boards 809 to 814 via serial communication lines, respectively.

The encoders 815 to 820 and 821 to 826 are respectively connected to the motor control boards 809 to 814 via serial communication lines, and exchange encoder information through serial communication. The encoders 815 to 820 and 821 to 826 transmit rotation angles of motor shafts, encoder states, and voltage values of the backup battery 848. The transmitted information related to the encoder is displayed on a monitor (display unit) of an external input device 847 via the control apparatus 802. The monitor mounted on the external input device 847 is a touch panel type, and can be operated by a user touching an operation screen.

Each arithmetic unit is connected to the control apparatus 802 via the communication unit and a serial communication line 846. Processing of driving a motor is executed based on command information including a control target value of each joint generated by a trajectory generator mounted on the control apparatus 802 and information on an encoder connected via the serial communication line and the serial communicator. In addition, as a response to command information transmitted from the control apparatus 802, processing of transmitting a rotation angle of a motor shaft, a voltage of a backup battery, error information, and the like to the control apparatus 802 is executed. The transmission and reception of command information and command responses between the control apparatus 802 and the motor control boards 809 to 814 are periodically performed. In the present exemplary embodiment, the transmission and reception are performed in a cycle of 2 milliseconds.

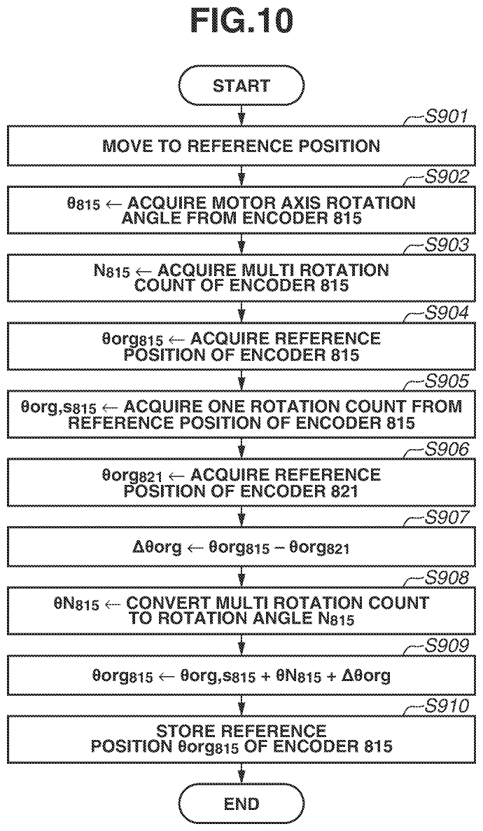

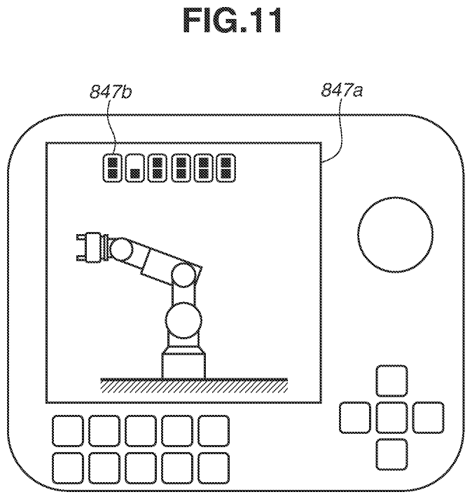

Next, regarding a reference position restoration method according to the present exemplary embodiment, a method for restoring a detected rotation angle and a reference position when the reliability of the detected rotation angle of the encoder 815 is reduced will be described with reference to FIG. 10. FIG. 10 is a control flowchart of the reference position restoration method according to the present exemplary embodiment. The control procedure in the present exemplary embodiment is executed by a CPU of the control apparatus 802 and the motor control boards 809 to 814 of the respective joints.

In FIG. 10, in step S901, the motor shaft of the motor 827 is moved to the vicinity of the reference position. As a method of moving to the vicinity of the reference position, a portion rotated by the rotation of the motor shaft via a reduction gear or the like is manually moved to the vicinity of a mark indicating the reference position, or the motor shaft is rotated to move. Here, it is not necessary to exactly match the motor shaft with the reference position, and for example, the motor shaft can be moved within about one rotational range of the motor shaft.

Next, in step 902, a motor shaft rotation angle detected from the encoder 815, which is a target for restoring the reference position, is acquired.

Next, in step 903, multi-rotation information is acquired from the rotation angle of the motor shaft acquired in step S902. For example, when the resolution (count value) of a single-rotation detection angle of the encoder 815 is Cs, the multi-rotation information can be acquired by dividing θ₈₁₅ (θ₈₁₅/Cs) by Cs and taking the integer part of the result as the number of rotations N₈₁₅.

In step S904, reference position information θorg₈₁₅ stored in the memory before the reliability of the encoder 815 is lowered is read.

Next, in step S905, processing of acquiring one rotation information from the reference position information on the encoder 815 acquired in step S904 and setting the one rotation information to θ_{org} and s₈₁₅ is executed. The one rotation information may be calculated from a remainder obtained by dividing the reference position θorg₈₁₅ by Cs, where Cs is the resolution (count value) of a one rotation detection angle of the encoder 815. Further, when the reference position is stored in the memory, the one rotation information and the number of rotations (multi-rotation) information may be stored separately.

In step S906, the reference position information on the encoder 821 is acquired from the memory.

In step 907, an angular difference Δθorg between the reference position information θorg 821 on the encoder 821 and the reference position information θorg 815 on the encoder 815 before the reliability of the encoder information on the encoder 815 decreases is acquired.

Then, in step S908, processing of converting the current multi-rotation information acquired in step S903 into a rotation angle θN₈₁₅ is executed.

Next, in step S909, new reference position information on the encoder 815 is acquired. The one rotation angle θ_{org}, s₈₁₅ of the reference position of the encoder 815, rotation angle information θ_{N815} acquired from the current multiple-rotation information, and the reference position difference Δθorg acquired from the reference position information of the encoder 815 and the reference position information on the encoder 821 are added. As a result, new reference position information θorg₈₁₅ on the encoder 815 is acquired.

In step S910, the new reference position information θorg₈₁₅ obtained in step S909 is stored in the nonvolatile memory, and the restoration of the reference position is completed. When the power of the robot system is turned off, the reference positions of the encoders 821 to 826 may be acquired from the reference positions of the encoders 815 to 820. Thus, in a case where the backup battery is provided in only one encoder, even when the power supply of the robot system is turned off, it is possible to acquire the reference positions of both encoders.

Further, as shown in FIG. 11, an example of a screen on which a state of the backup battery 848 provided in each joint is displayed on the monitor mounted on the external input device 847 is shown. A symbol for visually notifying a user of a voltage detection value of the backup battery connected to the encoders 815 to 820 installed in the joints 803 to 808 is displayed on an upper part of a monitor 847a. An icon 847b displays a voltage detection value of the backup battery of the encoders 815 to 820 installed in each joint. When the voltage detection value of the backup battery becomes equal to or lower than a predetermined voltage value, a user may be notified by displaying a voltage drop warning message for the backup battery on the monitor 847a or by a warning sound.

As described above, according to the present exemplary embodiment, the reference position and the detection value in the encoder 815 in which the abnormality has occurred are restored with the encoder 821 in which the abnormality has not occurred. In addition, when the power of the robot system is turned off, the reference position of the encoder 821 is acquired based on the reference position of the encoder 815 provided with the backup battery. The information on the encoder 821 is equivalent to the information on the encoder 815 before the occurrence of the abnormality, and the reference position rotation angle θorg₈₁₅ within one rotational range is not changed before and after the abnormality detection of the encoder 815. Therefore, the reference position before the abnormality detection of the encoder 815 can be restored. Since the information on the encoder 815 is restored with the encoder information (information of the encoder 821) before the abnormality occurs, it is not necessary to reset the reference position of the encoder 815 and the reference position of the joint 803, and it is not necessary to re-teach the operation of the robot arm body 200. Therefore, it is possible to reduce the stop time of the robot and to reduce a decrease in the operation rate of the robot. In addition, even when the detection angle resolution of the encoder 815 is different from the detection angle resolution of the encoder 821, restoration can be performed.

Further, by using an encoder capable of detecting one rotation information (does not multi-rotation information), it is possible to reduce the cost of the encoder itself and the number of backup batteries, so it is possible to achieve a reduction in the cost and space of the robot system. Further, the robot system can be environmentally friendly due to the reduction in the number of batteries. Further, the above-described various exemplary embodiments and modifications may be implemented in combination with the present exemplary embodiment.

### Other Embodiments

The processing procedures in the exemplary embodiments described above are specifically each executed by the CPU and the motor control board. Therefore, the present disclosure can also be configured to read and execute a software control program capable of executing the above-described functions from a recording medium storing the program. In this case, the program itself read from the recording medium implements the functions of the above-described exemplary embodiments, and thus the program itself and the recording medium on which the program is recorded are included in the present disclosure.

In each exemplary embodiment, a computer-readable recording medium is a ROM, a RAM, or a flash ROM, and a program is stored in the ROM, the RAM, or the flash ROM. However, the present disclosure is not limited to such an exemplary embodiment. The program for implementing the present disclosure may be recorded in any recording medium as long as it is a computer readable recording medium.

In addition, in the above-described various exemplary embodiments, the case where the multi-joint robot arm in which the robot arm body 200 has a plurality of joints is used has been described, but the number of joints is not limited thereto. As a type of robot arm, a vertical multi-axis configuration is shown, but a configuration equivalent to the above can also be implemented in joints of different types, such as a horizontal multi-joint type, a parallel link type, and an orthogonal robot.

In addition, the above-described various exemplary embodiments can be applied to a machine capable of automatically performing an operation of expansion and contraction, bending and stretching, vertical movement, horizontal movement, or turning, or a composite operation thereof on the basis of information in a storage device provided in a control apparatus.

The present disclosure is not limited to the above-described exemplary embodiments, and various modifications can be made within the technical idea of the present disclosure. Further, the effects described in the exemplary embodiments of the present disclosure are merely a list of the most preferable effects produced from the present disclosure, and the effects of the present disclosure are not limited to those described in the exemplary embodiments of the present disclosure. In addition, the above-described various exemplary embodiments and modifications may be implemented in combination.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2022-175969, filed Nov. 2, 2022, and No. 2023-149885, filed Sep. 15, 2023, which are hereby incorporated by reference herein in their entirety.

What is claimed is:

1. A robot having a joint, the robot comprising:
a first position sensor and a second position sensor configured to acquire information about a position of the joint,
wherein a first reference position of the first position sensor is acquired based on a second reference position of the second position sensor.

2. The robot according to claim 1,
wherein the first reference position is acquired based on the second reference position and a detection value from the second position sensor.

3. The robot according to claim 2,
wherein the first reference position is acquired based on the second reference position and a difference in number of rotations between the first position sensor and the second position sensor.

4. The robot according to claim 3, further comprising a nonvolatile storage unit in which the first reference position and the second reference position are stored.

5. The robot according to claim 1,
further comprising a power supply unit configured to supply power to the first position sensor,
wherein, in a case where a value related to the power of the power supply unit becomes a predetermined value, the first reference position is acquired based on the second reference position.

6. The robot according to claim 5,
wherein the value is a voltage value of the power supply unit.

7. The robot according to claim 5,
wherein it is determined that a detection value from the first position sensor is low in reliability when the value becomes the predetermined value.

8. The robot according to claim 5,
wherein a state of the power supply unit is displayed on a display unit.

9. The robot according to claim 8,
wherein a first message prompting a user to acquire the first reference position is displayed on the display unit.

10. The robot according to claim 8,
wherein a second message notifying a user that acquisition of the first reference position is being executed is displayed.

11. The robot according to claim 8,
wherein a third message notifying a user that acquisition of the first reference position is completed is displayed.

12. The robot according to claim 5,
further comprising a display device at the joint,
wherein the display device displays a state of the power supply unit.

13. The robot according to claim 5,
wherein the power supply unit functions as a backup of power supply to the first position sensor.

14. The robot according to claim 5,
wherein the power supply unit is provided for each of the first position sensor and the second position sensor.

15. The robot according to claim 5,
wherein the power supply unit is provided for one of the first position sensor and the second position sensor.

16. The robot according to claim 15,
wherein, based on the reference position of one of the first position sensor and the second position sensor on which the power supply unit is provided, the reference position of the other position sensor is acquired.

17. The robot according to claim 1,
wherein the first reference position and the second reference position are set corresponding to an origin of the joint.

18. The robot according to claim 1,
wherein the joint is configured to have a redundant configuration with the first position sensor and the second position sensor.

19. The robot according to claim 1,
wherein the joint includes a motor, and
wherein the first position sensor and the second position sensor detect a rotation angle of a motor shaft of the motor.

20. The robot according to claim 1,
wherein the joint includes a motor and a link that is driven by decelerating driving by the motor,
wherein the first position sensor detects a rotation angle of a motor shaft of the motor, and the second position sensor detects a rotation angle of the link.

21. The robot according to claim 1,
wherein the robot is a collaborative robot.

22. An article manufacturing method for manufacturing an article by using the robot according to claim 1.

23. A method for controlling a robot having a joint, the method comprising:
acquiring a first reference position of a first position sensor based on a second reference position of a second position sensor, the first position sensor and the second position sensor configured to acquire information about a position of the joint.

24. A non-transitory computer-readable recording medium storing a control program for causing a computer to execute the control method according to claim 23.
